(19) United States
(12) Patent Application Publication
(10) Pub. No.: US 2024/0064000 A1
(43) Pub. Date: Feb. 22, 2024

(54) HOMOMORPHIC ENCRYPTION METHOD AND ASSOCIATED DEVICES AND SYSTEM

(71) Applicant: RAVEL TECHNOLOGIES, PARIS (FR)

(72) Inventors: Michel KOSKAS, PARIS (FR); Philippe CHARTIER, RENNES (FR); Mohammed LEMOU, ACIGNÉ (FR); Florian MEHATS, RENNES (FR)

(21) Appl. No.: 18/268,103

(22) PCT Filed: Dec. 18, 2020
(86) PCT No.: PCT/IB2020/001147

§ 371 Date: Jun. 16, 2023

(51) Int. Cl. H04L 9/00

(52) U.S. Cl. CPC H04L 9/008

(57) ABSTRACT

An homomorphic encryption technique enables one to carry on operations on encrypted messages without decrypting them, these encrypted messages being associated to unencrypted messages that belong to a discrete set consisting of pᵢ distinct elements, with pᵢ being an odd number, the elements of the discrete set being such that twice the difference between any two of these elements is not an integer number, said discrete set being for instance the discrete torus Tₚᵢ={−(pᵢ−1)/2, −(pᵢ−1)/2+1, . . . , (pᵢ−1)/2−1, (pᵢ−1)/2}/pᵢ. In particular, a specific bootstrapping procedure form such encrypted messages is disclosed. The disclosed technology concerns also an homomorphic encryption technique for carrying on operations on encrypted messages associated to unencrypted messages that belong Zₚ, p being equal to the product of r integer numbers pᵢ, i=1 . . . r that are pairwise coprime. The disclosed technology concerns also associated electronic devices and systems implementing such techniques.

### TECHNICAL FIELD

The disclosed technology concerns methods, devices and systems for homomorphic encryption.

### BACKGROUND

Homomorphic encryption, which allows one to perform calculations or data processing on encrypted data, without decrypting it first, has attracted a lot of attention recently.

Indeed, digital data processing of personal data has become ubiquitous in our everyday lives. Confidentiality and privacy protection of such data has thus become critical, as such personal data tends to circulate more and more in our digital environment.

In this context, homomorphic encryption is a very promising solution, as it enables to process data while preserving very securely data anonymization and privacy at the same time, as the data is not decrypted during its processing.

Homomorphic encryption is usually based on the “learning with error” encryption scheme, in which the encrypted message c=(a,b) is derived from the unencrypted message m according to the following formula: b=m+e+a·s, where:
s is a secret key,
a is randomly chosen vector, for projecting the secret key s, and
e is a random noise component, added to m+a·s.

To decrypt the message, someone possessing the secret key s may compute the quantity b−a·s (equal to m+e), and then round the result to remove the noise component e and retrieve the message m. Of course, the noise term e has to be, and to remain small enough, if one wants to be able to retrieve the message m.

When two encrypted messages are summed up, or even worse, when they are homomorphically multiplied together, one obtains an encrypted message, which is an encrypted version of the sum, or product of the two initial, unencrypted messages, whose noise component is higher than for the two initial encrypted messages.

So, to prevent the noise term from increasing and increasing in the course of data processing, a refreshing procedure, usually named “bootstrapping”, is executed repeatedly, usually after each operation on the encrypted message c. This procedure produces a refreshed version of c, that is an encrypted message c′ which is decrypted as m (when decrypted using s), and whose noise component is smaller than the one of c.

The bootstrapping procedure usually comprises the homomorphic (that is: in encrypted form) computation of X^{q}·V(X) where:
V(X) is the following polynomial: +X+X²+X³+ . . . +X^{N-1},
and q is equal to the integer number that is the nearest to 2N(b−a·s):

q=└2N(b−a·s)┐

The constant term of X^{q}·V(X) mod (X^{N}+1), that is coef₀(X^{q}·V(X)), is a refreshed version of c: it is an encrypted version of m, but with a noise component e′ smaller than the noise component e of c.

One may note that the initial noise e is somehow washed out when (homomorphically) computing q, thanks to the rounding operation └ ┐. In this operation, the factor 2N plays the role of an expansion factor, that enables to spread the possible values of b−a·s (impaired by some noise) sufficiently, before rounding.

Such a bootstrapping procedure is very useful and ingenious, but also very time-consuming (in particular because the operations involved have to be carried on homomorphically), all the more that it has to be executed repeatedly.

The homomorphic encryption scheme succinctly described above, which combines “learning with error” and a bootstrapping procedure, is usually carried on with binary messages (that is, messages whose values are either 0 or 1). Indeed, in this technical field, most of the tools have been specifically developed and optimized for such messages.

To perform homomorphic operations on a longer message, the message is decomposed into binary messages (classical binary decomposition), each binary message is encrypted separately, and the operation is then carried on, homomorphically, bit by bit. But in this process, one has to take into account the (encrypted) carry resulting from each binary addition, and to propagate this carry to the next binary operation. The process is thus a serial one, which is time consuming. Besides, each binary operation is carried homomorphically, which multiplies the number of homomorphic (and thus time-consuming) operations.

### SUMMARY

In this context, a homomorphic encryption technology, that enables to process efficiently messages longer than binary ones, is disclosed.

An aspect of this technology concerns a method for determining an encrypted message cᵢ, which is an encrypted version of a message mᵢ, cᵢ being equal to (aᵢ,bᵢ) where bᵢ is determined from mᵢ and from a secret key s, bᵢ being equal to mᵢ+eᵢ+aᵢ·s with aᵢ being a randomly selected vector for projecting s and eᵢ being a random noise component added to mᵢ+aᵢ·s,

wherein the message mᵢ belongs to a discrete set consisting of pᵢ distinct elements, with pᵢ being an odd number and wherein the elements of said discrete set are such that twice the difference between any two of these elements is not an integer number, said discrete set being the discrete torus

$${T}_{pi} = \frac{1}{{p}_{i}} \{ - \frac{{p}_{i} - 1}{2} , - \frac{{p}_{i} - 1}{2} + 1 , … , \frac{{p}_{i} - 1}{2} - 1 , \frac{{p}_{i} - 1}{2} \} ,$$

or the set T_{pi,N}[X] of polynomials of degree N−1 whose coefficients belong to Tₚᵢ, or another discrete set in bijective relationship with Tₚᵢ.

The inventors have developed a homomorphic cryptographic technique for such “long” messages (longer than binary messages), enabling, among other things, adding, multiplying and refreshing (i.e.: bootstrapping) these messages while they remain encrypted. These operations are carried on without decomposing the message into binary, independently encrypted, smaller messages. In other words, the encrypted message is treated as a whole, with no decomposition onto smaller fields.

So, the burden of dealing with encrypted carries and serial processing of the numerous and encrypted bits is avoided.

It may be noted that the fact that a homomorphic processing is possible for long messages (without decomposing it), and the fact that this processing can be fast and efficient is far from being an immediate, straightforward result.

Indeed, as mentioned above, most of the homomorphic cryptography tools currently available are adapted specifically to binary messages. So, the inventors had to go against the usual practice and prejudices and had to move forward in the development of specific (and elaborated) tools intended for longer messages, without knowing whether a direct homomorphic processing of long messages was actually possible or not, or whether it could be executed efficiently or not. In particular, the inventors had to elaborate a new homomorphic multiplication scheme and a new bootstrapping method (presented below), to develop such an encryption protocol. Only once these quite complex tools had been developed could the inventors be sure that such a treatment could actually be carried out.

And, in the process of developing these new tools, the inventors realized that working with messages belonging to the discrete Torus Tₚᵢ, or to the set of polynomials T_{pi,N}[X], or to another equivalent discrete set, with:
pi being an odd number,
and such that for any couple grouping two of the elements of said set, twice the difference between these two elements is not an integer number
   was very fruitful, as it turns out that these specific features make different operations, involved in the multiplication and bootstrapping process mentioned above, feasible (as will be described in more details later).

The fact that a direct homomorphic processing of a “long” message is not only possible, but that it can also be achieved efficiently, in a limited time, is also far from obvious, at first glance.

Indeed, when the message mᵢ is long, that is when the integer number pᵢ is quite large, for example equal to 17, 21, or more, one would expect at first sight to have to use polynomials whose degree N−1 is high, during bootstrapping operations. Indeed, as explained above, in the calculation of the quantity q, the integer N acts as a kind of expansion coefficient. So, when pᵢ is large, as the possible values of the message mᵢ (distributed in the interval]−1/2;1/2]) are then close to each other, one expects to have to choose a number N that is large, in order to be able to spread these values sufficiently apart, before the rounding operation involved in the calculation of the quantity q. And a large N considerably increases the calculation time.

More precisely, a rough estimate leads to the conclusion that N would have to be of the order of 10000 (with pi=20 and n=500, for instance), or greater, for the bootstrapping operation to work properly (that is with a low probability of losing of degrading the message m during this operation). And such values of N are almost prohibitive, in terms of computation time.

But in fact, a complete, acute probability calculation shows that such a bootstrapping operation can be successfully performed with polynomials whose degree N−1 is much smaller than what the first approximate estimate mentioned above suggests. More precisely, it can be shown that an integer number N of the order of 1000 (e.g. 1024) turns out to be sufficient for typical values of pi (about 20-40, for example).

According to the disclosed technology, N may be selected as small as 50 times pᵢ, or below, or even below 30 times pᵢ, to take advantage of this surprisingly favorable scaling and accelerate the bootstrapping processing.

The method for bootstrapping developed by the inventors, mentioned above, is a method for bootstrapping an encrypted message cᵢ=(aᵢ,bᵢ) determined as described above, this method comprising a determination of a refreshed encrypted message cᵢ′=(aᵢ′,bᵢ′), which is an encrypted version of a value g(mᵢ) of a function g applied to the message mᵢ, cᵢ′ having a noise component eᵢ′ smaller than eᵢ.

The determination of cᵢ′ comprises a step of determining homomorphically the constant coefficient coef₀(X^{q}·W_{g}(X)) of X^{q}·W_{g}(X) mod (X^{N}+1),
where W_{g}(X)=Σⱼ₌₀^{N-1}wⱼ·X^{j} is a polynomial of degree N−1, whose coefficients wⱼ are given by the following formula:

(−1)^{┌└2Nm}^{ᵢ}^{┐/N┐}·wⱼ=g(mᵢ), where j=N┌└2Nmᵢ┐/N┐−└2Nmᵢ┐

with └2Nmᵢ┐ being the integer number that is the nearest to 2Nmᵢ and with ┌└2Nmᵢ┐/N┐ being the ceiling function applied to └2Nmᵢ┐/N,
and where q is the integer number that is the nearest to 2N(bᵢ−aᵢ·s): q=└2N (bᵢ−aᵢ·s)┐.

So, during this bootstrapping operation, in addition to reducing (refreshing) the noise component of a cipher text, an arbitrary function g can be applied to the corresponding message mᵢ.

This accelerates considerably numerous data processing routines. Indeed, to apply such a function g to a message, instead of: carrying on an elementary operation (homomorphically), then bootstrapping the result (to counter the noise increase due to the preceding operation), carrying on another elementary operation, then bootstrapping the result, and so on, one just has to execute one time the special bootstrapping procedure presented above.

In this bootstrapping procedure, the degree N−1 of the polynomial Wg(X) may be selected so as to be above pᵢ, or even above 5 times pᵢ.

The disclosed technology concerns also a method for homomorphically multiplying two messages m1ᵢ and m2ᵢ, each belonging to the discrete torus Tₚᵢ or to the set of polynomials T_{pi,N}[X], the method comprising a determination of an encrypted message c3ᵢ which is an encrypted version of the product of m1ᵢ by m2ᵢ, c3ᵢ being determined from encrypted versions c1ᵢ and c2ᵢ of the messages m1ᵢ and m2ᵢ, without decrypting c1ᵢ or c2ᵢ, the method comprising homomorphically determining

$$\frac{( {p}_{i} + 1 )}{2} \cdot [ \frac{( {p}_{i} + 1 )}{2} \cdot {p}_{i} \cdot {( m {1}_{i} + m {2}_{i} )}^{2} - \frac{( {p}_{i} + 1 )}{2} \cdot {p}_{i} \cdot {( m {1}_{i} - m {2}_{i} )}^{2} ]$$

Where pᵢ·(m1ᵢ+m2ᵢ)² and pᵢ·(m1ᵢ−m2ᵢ)², or

$$\frac{( {p}_{i} + 1 )}{2} \cdot {p}_{i} \cdot {( m {1}_{i} + m {2}_{i} )}^{2} and$$

$$\frac{( {p}_{i} + 1 )}{2} \cdot {p}_{i} \cdot {( m {1}_{i} - m {2}_{i} )}^{2} , or$$

$${[ \frac{( {p}_{i} + 1 )}{2} ]}^{2} \cdot {p}_{i} \cdot {( m {1}_{i} + m {2}_{i} )}^{2} and$$

$${[ \frac{( {p}_{i} + 1 )}{2} ]}^{2} \cdot {p}_{i} \cdot {( m {1}_{i} - m {2}_{i} )}^{2}$$

are determined homomorphically by executing the method for bootstrapping presented above, the function g being the function g_{sq′}:mᵢ→pᵢ·(mᵢ)², or

$${ℊ}_{sq} : {m}_{i} \to \frac{( {p}_{i} + 1 )}{2} \cdot {p}_{i} \cdot {( {m}_{i} )}^{2} ,$$

or, respectively,

$${ℊ}_{sq ″} : {m}_{i} \to {[ \frac{( {p}_{i} + 1 )}{2} ]}^{2} \cdot {p}_{i} \cdot {( {m}_{i} )}^{2} .$$

It may be noted that the tools presented above, for homomorphic processing of messages mᵢ belonging to such a discrete set of pᵢ elements (with pᵢ odd), can, in addition to their own benefits, be applied in an extremely beneficial manner to a cryptographic technic for even longer messages, decomposed into smaller components mᵢ, based on the Chinese remainder theorem decomposition, which, again, enables to avoid the burden of dealing with carries (so, in other words, the tools mentioned above are some kinds of basic bricks of this Chinese-remainder processing method, presented in more detail below).

The disclosed technology concerns also a method for determining an encrypted message c_{f,i}, which is an encrypted version of a value f(m1ᵢ,m2ᵢ) of a two-variable function f applied to messages m1ᵢ and m2ᵢ, m1ᵢ and m2ᵢ belonging each to the discrete set mentioned above (for instance the torus Tₚᵢ or the set of polynomials T_{pi,N}[X]),
c_{f,i} being determined from encrypted messages c1ᵢ and c2ᵢ without decrypting c1ᵢ or c2ᵢ, c1ᵢ and c2ᵢ being encrypted versions of m1ᵢ and m2ᵢ respectively, that have been determined according to the method for encrypting presented above,
the determination of c_{f,i} comprising:
   determining c1′ᵢ and c2′ᵢ, from c1ᵢ and c2ᵢ respectively, by executing the method for bootstrapping presented above, the function g employed during this bootstrapping being a function gₘₐₚ that maps said discrete set onto a set S whose elements μ ⱼ belong each to the torus T=]−1/2,1/2] and are such that, for any set of indexes (i,j,k,l) with (i,j)≠(k,l), (k,l) being different from (j,i): α·μᵢ+β·μⱼ is different from α,μₖ+β·μₗ modulo ½, with α and β being two constant and integer, given numbers,
   c1′ᵢ and c2′ᵢ being the encrypted versions of m1ᵢ=gₘₐₚ(m1ᵢ) and m2ᵢ=gₘₐₚ(m2ᵢ) respectively, where m1ᵢ and m2ᵢ belong each to S,
   determining homomorphicically, from c1′ᵢ and c2′ₗ, an encrypted message cₛ which is an encrypted version of α·m1ᵢ+β·m2ᵢ,
   determining c_{f,i} from cₛ by executing the method for bootstrapping presented above, the function g employed during this bootstrapping being a one-variable function g_{f} from T to Tₚᵢ, defined by the following condition:
   for any couple of messages m1ⱼ, m2ⱼ belonging each to said discrete set,

g_{f}(α·m1ⱼ+β·m2ⱼ)=f(m1ⱼ, m2ⱼ)
that is:

g_{f}[α·gₘₐₚ(m1ⱼ)+β·gₘₐₚ(m2ⱼ)]=f(m1ⱼ, m2ⱼ).

According to an aspect of this technology, the elements of the set S are such that for any set of indexes (i,j,k,l) with (i,j)≠(k,l), α·μᵢ+β·μⱼ is different from α·μₖ+β·μₗ modulo ½, even when (k,l)=(j,i). In this case, one may have, in particular: α=1 and β=−1, cₛ being determined by computing the homomorphic difference ⊖ between c1′ᵢ and c2′: cₛ=c1′ᵢ⊖c2′ᵢ, or α=−1 and β=1, cₛ being determined by computing the homomorphic difference ⊖ between c2′ᵢ and c1′: cₛ=c2′ᵢ⊖c1′ᵢ.

According to another aspect of this technology, the function f is symmetric, f(m1ᵢ,m2ᵢ) being equal to f(m2ᵢ,m1ᵢ) for any couple of messages m1ᵢ and m2ᵢ, α and β are each equal to 1, and cₛ is determined by computing the homomorphic sum ⊕ of c1′ᵢ and c2′: cₛ=c1′ᵢ⊕c2′ᵢ.

The disclosed technology also concerns such a method for determining an encrypted message c_{f,i}, which is an encrypted version of a value f(m1ᵢ,m2ᵢ) of a two-variable function f, as such, independently from the bootstrapping method in question. Indeed, as the skilled person will appreciate, the method for homomorphically evaluating f, based on the intermediate mapping of said discrete set (e.g.: Tₚᵢ) onto S, can be achieved independently from this specific bootstrapping procedure, using any method for homomorphically mapping said discrete set on S (the mapping method being possibly different from the one described above), and using then any method for homomorphically applying a function like the function g_{f} to the quantity α·m1ᵢ+β·m2ᵢ.

According to an aspect of the disclosed technology, any of the methods presented above is executed by a computer (programmed or otherwise arranged to execute the method in question), that is an electronic device or system (possibly distributed among several distant, remote devices) comprising at least one processor for executing logical operations, and one memory device for storing data.

In particular, an aspect of the technology concerns an encrypting device, comprising one or more processors and at least one memory, the encrypting device being programmed to make the processor or processors executing the following steps:
receiving data representative of an unencrypted message mᵢ, that belongs to the discrete set mentioned above,
processing said data according to the method for encrypting presented above, to determine encrypted data representative of the encrypted message cᵢ, the secret key s employed during said processing, stored at least transitorily in the memory of the encrypting device, being accessed by the processor or processors during said processing.

An aspect of the disclosed technology concerns a cryptographic system comprising such an encrypting device and a processing device,
the processing device comprising one or more processors and at least one memory, the processing device being programmed to make the processor or processors executing the following steps:
   receiving data, representative of an encrypted message cᵢ produced by the encrypting device,
   processing said data, according to the method for bootstrapping that has been presented above, to determine refreshed data, representative of the encrypted message c′ᵢ, said processing being achieved without decrypting cᵢ and without using, reading or accessing the secret key s.

In particular, the secret key s may be completely absent from the processing device (which is a separate device distinct from the encrypting device), and remain absent from the processing device at all time.

The disclosed technology also concerns such a processing device, as such, independently from the encrypting device.

The processing device may also be programmed to execute the method for multiplying presented above, and the method for determining an encrypted message c_{f,i}, which is an encrypted version of a value f(m1ᵢ,m2ᵢ) of the two-variable function f.

The disclosed technology concerns also a computer-readable program product comprising instructions that, when executed by a computer, make the computer to execute any of the method presented above.

The disclosed technology concerns also a method for determining an encrypted message C, which is an encrypted version of a message x belonging to [symbol] ₚ= [symbol] /p [symbol] , p being equal to Πᵢ₌₁^{r}pᵢ where the integer numbers pᵢ are pairwise coprime, the method comprising:
decomposing x into its components xᵢ, i=1 . . . r, with xᵢ equal to x modulo pᵢ,
for each component xᵢ whose associated factor pᵢ is odd, determining an encrypted version cᵢ of a message mᵢ, according to the method for encrypting that has been presented above mᵢ being, among the elements of said discrete set, the element that is associated to xᵢ by a given bijective relationship between [symbol] ₚᵢ and said discrete set,
if a component xᵢ is associated to a factor pᵢ equal to 2, determining an encrypted version cᵢ of a quantity Qᵢ associated to xᵢ and that can takes two distinct values cᵢ being equal to (aᵢ,bᵢ) with bᵢ=Qᵢ+eᵢ+aᵢ·s,
returning C=(c₁, . . . cᵢ, . . . cᵣ).

An aspect of this technology concerns a method for bootstrapping the encrypted message C=(c₁, . . . cᵢ, . . . cᵣ) determined according the encrypting method that has just been described, this (generalized) bootstrapping method comprising:
for each cᵢ whose associated factor pᵢ is odd, determining a refreshed encrypted message C′ᵢ, from cᵢ, by executing the method for bootstrapping that has been presented before,
returning C′=(c′₁, . . . , c′ᵢ, . . . c′ᵣ).

This technology concerns also a method for determining an encrypted message C3=(c3₁, . . . c3ᵢ, . . . c3r), which is an encrypted version of the product of two messages x1 and x2, each belonging to [symbol] ₚ,
C3 being determined from encrypted messages C1 and C2, without decrypting C1 or C2, C1 and C2 being encrypted versions of x1 and x2 respectively, C1=(c1₁, . . . c1ᵢ, . . . c1ᵣ) and C2=(c2₁, . . . c2ᵢ, . . . c2ᵣ) having been determined from x1 and x2 respectively, according to the method for encrypting that has just been presented, wherein said discrete set is Tₚᵢ or T_{pi,N}[X], and
wherein each component c3ᵢ of C3 is determined from the corresponding components c1ᵢ and c2ᵢ of C1 and C2, according to the method for multiplying that was described above for messages belonging to the discrete torus Tₚᵢ, when c1ᵢ and c2ᵢ are associated to a factor pᵢ that is odd.

The disclosed technology concerns such a method for bootstrapping a message C, or such a method for multiplying homomorphically two messages x1 and x2, in itself, independently from the bootstrapping method (for messages belonging to Tₚᵢ) that has been presented above. Indeed, as the skilled person will appreciate, these two methods, for processing encrypted messages, associated to unencrypted messages x belonging to Zₚ (with p being equal to Πᵢ₌₁^{r}pᵢ where the integer numbers pᵢ are pairwise coprime), take advantage of the Chinese remainder theorem to process the encrypted “sub-messages” cᵢ, i=1 . . . r, independently from each other, without having to deal with, or anyhow considering (encrypted) carries. This technique could clearly be applied using other “sub-routines” than the one presented above, for the homomorphic processing of the sub-messages mᵢ. In particular, any multiplying or bootstrapping method for elements belonging to the discrete set mentioned above (e.g.: the discrete torus Tₚᵢ) could be used, instead of the one described above.

According to the disclosed technology, these encrypting and processing techniques (based on a “Chinese remainder” decomposition), could be executed by a computer.

The disclosed technology concerns also an electronic device, comprising at least one processor and one memory, programmed or otherwise configured to execute one of these methods. The disclosed technology concerns also a computer-readable program product comprising instructions, whose execution by a computer make the computer to execute anyone of these methods.

### BRIEF DESCRIPTION OF THE DRAWINGS

Other characteristics and benefits of the disclosed technology will become clear from the description which is given below, by way of example and non-restrictively, in reference to the figure, in which:

FIG. 1 represents, as a block-diagram, operations carried on to multiply homomorphically two messages.

FIG. 2 represents, as a block-diagram, operations carried on to evaluate homomorphically a two-variable function.

FIG. 3 represents, as a block-diagram, an encryption step of a long message x, based on a Chinese remainder decomposition.

FIG. 4 represents, as a block-diagram, operations carried on to add homomorphically two encrypted messages obtained previously according to the encryption step of FIG. 3.

FIG. 5 represents, as a block-diagram, operations carried on to multiply homomorphically two encrypted messages, obtained previously according to the encryption step of FIG. 3, said multiplication comprising several sub-multiplications carried on according to the process represented in FIG. 1.

FIG. 6 schematically illustrate a cryptographic system according to the disclosed technology.

### DETAILED DESCRIPTION

As mentioned above, the disclosed technology concerns an homomorphic encryption technique that enables to carry on operations on encrypted messages without decrypting them, these encrypted messages being associated to unencrypted messages that are each longer than a single bit, and that are processed without being decomposed into individual binary messages.

The disclosed technology concerns more particularly a technique for encrypting and processing messages mᵢ, that belong to a discrete set consisting of pᵢ distinct elements, with pᵢ being an odd number, these messages being encrypted and processed directly, without decomposing these messages into smaller (for instance binary) messages that would be encrypted separately. This technology is presented below in the case where the discrete set in question is the discrete torus

$${T}_{pi} = \frac{1}{{p}_{i}} \{ - \frac{{p}_{i} - 1}{2} , - \frac{{p}_{i} - 1}{2} + 1 , … , \frac{{p}_{i} - 1}{2} - 1 , \frac{{p}_{i} - 1}{2} \} ,$$

or the set T_{pi,N}[X] of polynomials of degree N−1 whose coefficients belong to Tₚᵢ. Still, as the skilled person will appreciate, this technology can be applied as well (possibly, with minor modifications for the homomorphic addition or multiplication) to another discrete set of messages in bijective relationship with Tₚᵢ, like

$${ℤ}_{pi} = ℤ / {p}_{i} ℤ or \frac{1}{{p}_{i}} \{ - \frac{{p}_{i} - 1}{2} + 1 , … , \frac{{p}_{i} - 1}{2} - 1 , \frac{{p}_{i} - 1}{2} , \frac{{p}_{i} - 1}{2} + 1 \}$$

(that is Tₚᵢ with an offset of +1/pᵢ; it may be noted that for this alternative example, the different operations described below—including the bootstrapping procedure, but also the homomorphic multiplication—can be implemented in the same manner as in the case of Tₚᵢ, even if the values may have to be shifted to reintegrate them in the interval [−1/2, 1/2[) for instance.

The disclosed technology concerns also a technique for encrypting and processing even longer messages x, using a specific decomposition of the message x into smaller messages mᵢ, this decomposition being based on the Chinese remainder theorem decomposition and enabling to process the sub-messages mᵢ separately from each other, without having to take into account possible carries.

The encryption technique for encrypting and processing a message mᵢ, without decomposing it, will be presented first. The technique for encrypting and processing a longer message x, composed of several such messages mᵢ, based on a Chinese remainder theorem decomposition, will be presented then. Finally, electronic devices and systems for implementing such methods will be presented.

Homomorphic encryption and processing of a message mᵢ belonging to Tₚᵢ, or to T_{pi,N}[X].

As mentioned above, this homomorphic encryption technique is applied to messages mᵢ that belong to the discrete torus

$${T}_{pi} = \frac{1}{{p}_{i}} \{ - \frac{{p}_{i} - 1}{2} , - \frac{{p}_{i} - 1}{2} + 1 , … , \frac{{p}_{i} - 1}{2} - \frac{{p}_{i} - 1}{2} \} ,$$

or to the set T_{pi,N}[X] of polynomials of degree N−1 whose coefficients belong to Tₚᵢ.

More precisely, the set of polynomials T_{pi,N}[X] is the finite field composed of the polynomials of degree N−1 defined modulo X^{N}+1, and whose coefficients belong to Tₚᵢ: T_{pi,N}[X]=Tₚᵢ[X]/(X^{N}+1).

Remarkably, the integer number pᵢ is odd (which makes some of the operations described below possible).

### Encryption

An unencrypted message mᵢ, belonging to Tₚᵢ, is encrypted according to the “learning with error” scheme: the encrypted message cᵢ=(aᵢ,bᵢ) (or, in other words, the cypher text cᵢ), which is the encrypted version of mᵢ, is determined by:
randomly choosing a vector aᵢ, and
computing the quantity bᵢ=mᵢ+eᵢ+aᵢ·s where s is a secret key and where eᵢ is a noise component, added to mᵢ+aᵢ·s.

When mᵢ belongs to Tₚᵢ, the noise component eᵢ belongs to the torus T=]−1/2,1/2]. And when mᵢ belongs to T_{pi,N}[X], eᵢ belongs to the set T_{N}[X] of polynomials of degree N−1, defined modulo (X^{N}+1) and whose coefficients belong each to T. eᵢ is randomly chosen according to a predefined statistical distribution. At least one feature of this distribution, for instance its standard deviation (or the standard deviation of each of its coefficients, when eᵢ is a polynomial), is determined depending on the integer number pᵢ. For instance, the standard deviation of this distribution is all the smaller than pᵢ is high (this standard deviation may be inversely proportional to pᵢ, for example).

The secret key s is a vector having n components, each belonging to the set of integers Z, or to the set of polynomials of degree N−1, defined modulo (X^{N}+1) and whose coefficients belong each to Z. In other words, s belongs to Zⁿ, or to Z_{N}[X]ⁿ, where Z_{N}[X]=Z[X]/(X^{N}+1). The secret key s may more particularly belong to Bⁿ, or to B_{N}[X]n, where B={0, 1} (B being the set constituted by the binary values 0 and 1).

The vector aᵢ has also n components, and is such that the scalar product aᵢ·s belongs either to Tₚᵢ (when mᵢ belongs to Tₚᵢ), or to T_{pi,N}[X] (when mᵢ belongs to T_{pi,N}[X]). For instance, if mᵢ belongs of Tₚᵢ, and if s belongs to Bⁿ, aᵢ belongs to Tₚᵢⁿ (each of the n components of aᵢ belongs to Tₚᵢ).

In the following, for the sake of clarity, we consider that mᵢ belongs to Tₚᵢ, and that s belongs to Zⁿ or Bⁿ.

Besides, in the following, we consider more specifically that s belongs to Bⁿ (which simplifies some of the operations involved in the bootstrapping procedure described below).

To decrypt the encrypted message cᵢ=(aᵢ,bᵢ), a decryption module or a decryption device that has access to the secret key s computes bᵢ−aᵢ·s (which is equal to mᵢ+eᵢ), and then rounds it to the nearest value belonging to the discrete Torus Tₚᵢ, thus removing the noise component eᵢ and obtaining mᵢ.

The encrypted message cᵢ, obtained by encrypted mᵢ using the secret key s, may be also noted \tilde{φ}ₛ(mᵢ).

### Homomorphic Operations

An objective of the instant technology is to carry on operations homomorphically, that is to say to carry on operations on one, two or more messages m1ᵢ, m2ᵢ, . . . , but using their encrypted version c1ᵢ, c2ᵢ, . . . (instead of the unencrypted messages m1ᵢ, m2ᵢ, . . . ) and without decrypting them, without knowing or having access to the secret key s.

More generally, determining homomorphically a given quantity is meant determining an encrypted version of this quantity, on the basis of encrypted messages, without using or determining unencrypted versions (unencrypted counterparts) of these encrypted messages, and without using (in particular without accessing) the secret key s.

In practice, it is particularly interesting to be able to achieve two-operands homomorphic operations, like a homomorphic addition, multiplication or comparison of two messages (which is very useful for sorting encrypted data without decrypting them).

In the case of a two-operands operation, the usual (“normal”) operation, whose operands are m1ᵢ and m2ᵢ, is noted Op and its result is noted m3ᵢ: m3ᵢ=Op(m1ᵢ,m2ᵢ). The corresponding homomorphic operation (that is, the homomorphic counterpart of Op) is noted Hop. So, the homomorphic operation Hop is an operation:
whose operands are two cipher texts c1ᵢ and c2ᵢ, which are encrypted versions of two messages m1ᵢ and m2ᵢ respectively (each belonging to Tₚᵢ);
which produces a cipher text c3ᵢ=Hop(c1ᵢ,c2ᵢ), that it determined from c1i and c22i without decrypting c1i or c2i, without using the secret key s (in particular, without knowing or accessing the secret key s);
the cipher text c3ᵢ being an encrypted version of m3ᵢ=Op(m1ᵢ,m2ᵢ).

In other words, when decrypting c1ᵢ, c2ᵢ and c3ᵢ using the secret key s, one gets respectively m1ᵢ, m2ᵢ and m3ᵢ=Op(m1ᵢ,m2ᵢ).

### Homomorphic Addition

The homomorphic addition is noted ⊕, (Hop=⊕). The homomorphic addition of two cipher texts, c3ᵢ=c1ᵢ⊖c2ᵢ, is readily achieved by summing the two cipher texts c1ᵢ=(a1ᵢ,b1ᵢ) and c2ᵢ=(a2ᵢ,b2ᵢ) component by component: c3ᵢ=(a3ᵢ,b3ᵢ) with a3ᵢ=a1ᵢ+a2ᵢand b3ᵢ=b1ᵢ+b2ᵢ.

Indeed, b3ᵢ−s·a3ᵢ=m1ᵢ+m2ᵢ+e1ᵢ+e2ᵢ is rounded as m1ᵢ+m2ᵢ (provided that e1ᵢ+e2ᵢ is small enough). So, c3ᵢ=c1ᵢ⊕c2ᵢ is indeed decrypted as m3i=m1ᵢ+m2ᵢ.

A homomorphic subtraction ⊖ can be achieved similarly by subtracting two cipher texts component by component.

A homomorphic multiplication for messages belonging to the discrete torus is much more complicated to develop and to implement. It will be presented later, after having described a new bootstrapping technique for messages belonging to the discrete torus (as this bootstrapping technique is used to carry on the homomorphic multiplication in question).

### Method for Bootstrapping an Encrypted Message cᵢ

A method for bootstrapping an encrypted message cᵢ=(aᵢ,bᵢ), that had been determined, as described above, by encrypting a message mᵢ using the secret key s, is presented below.

This method comprises a homomorphic determination of a refreshed encrypted message cᵢ′=(aᵢ′,bᵢ′), which is an encrypted version of a value g(mᵢ) of a function g applied to the message mᵢ, cᵢ′ having a noise component eᵢ′ smaller than the noise component eᵢ of cᵢ. The result cᵢ′ of this bootstrapping method, applied to cᵢ, is noted G(cᵢ).

So, this new bootstrapping method is a bootstrapping method adapted to messages mᵢ that belong to the discrete torus Tₚᵢ. It enables to refresh encrypted messages cᵢ associated to such messages mᵢ, that is to say to reduce the noise components eᵢ of these cypher texts cᵢ. And it enables also, at the same time, to apply an arbitrary function g to the message mᵢ. In other words, this method enables to homomorphically determine the value g(mᵢ) of the function g, applied to mᵢ.

The function g can be any function from Tₚᵢ to Tₚᵢ. In other words, g maps elements of Tₚᵢ to elements of Tₚᵢ (or elements of T_{pi,N}N[X] to elements of T_{pi,N}[X]).

The determination of cᵢ′ comprises a step of determining homomorphically the constant coefficient coef₀(X^{q}·W_{g}(X)) of a polynomial X^{q}·W_{g}(X) mod (X^{N}+1), where q is the integer number that is the nearest to 2N(bᵢ−aᵢ·s): q=└2N(bᵢ−aᵢ·s)┐.

The homomorphic determination of coef₀(X^{q}·W_{g}(X)) is carried on in a way similar to prior art techniques, like described in section 6 of Ilaria Chillotti, Nicolas Gama, Mariya Georgieva, and Malika Izabachène, “TFHE: Fast fully homomorphic encryption over the torus”, Journal of Cryptology, 33(1):34-91, 2020, for instance, but using a specially designed polynomial W_{g}(X), associated to the function g considered.

The coefficients of the polynomial W_{g}(X), of degree N−1, are noted wⱼ:

w_{g}(X)=Σⱼ₌₀^{N-1}wⱼ·X^{j}

They belong each to Tₚᵢ and are determined as follow.

Let's consider a function f_{w}, from Z to Tₚᵢ, defined as:

f_{w}:z→f_{w}(z)=(−1)^{┌z/N┐}·w_{j′} where j′=N┌z/N┐−z

┌·┐ denoting the ceiling function.

The coefficients wⱼ of W_{g}(X) are then defined, depending on g, such that, for any mᵢ belonging to Tₚᵢ:

f_{w}(└2Nmᵢ┐)=g(mᵢ)

So, the coefficients wⱼ are related to the function g by the following equation:

(−1)^{┌└2Nm}^{┐/N┐}·w_{j′}=g(mᵢ), where j′=N┌└2Nmᵢ┐/N┐−└2Nmᵢ┐

It can be proven that, given that pᵢ is odd, and that twice the difference between any two of the elements of the discrete set considered (namely Tₚᵢ, here) is not an integer number:
a) it is possible, for any function g from Tₚᵢ to T (and more generally for any function from any discrete set of pᵢ elements such as defined above, to T), to construct a corresponding function f_{w}, and thus a polynomial W_{g}(X), that fulfills the conditions given above, and that
b) thanks to this particular choice of polynomial (i.e.: thanks to the use of the particular polynomial W_{g}(X)), homomorphically determining coef₀(X^{q}·W_{g}(X)) actually leads to the determination of an encrypted version of g(mᵢ).

The detailed (and quite elaborate) proof of these results is not presented here, for the sake of conciseness and as it not directly useful in view of implementing the instant technology.

Still, it is noted that point a) is far from being immediate. Indeed, it can be readily noted that, for any z belonging to Z,

f_{w}(z+N)=−f_{w}(z)=f_{w}(z−N)

So the function f_{w} defined above is quite constrained, and a detailed analysis is in fact required to ensure that an adequate f_{w} function can actually be constructed for any function g (provided that the conditions above, regarding pᵢ and the elements of the set, are fulfilled).

It may be noted that this bootstrapping technique, presented above in the case where the discrete set with pᵢ elements is Tₚᵢ (or T_{pi,N}N[X]), can be applied as well in the case of another discrete set consisting of pᵢ elements (with pi odd, and such that twice the difference between any two of the elements of this set is not an integer number). In particular, the formula giving the values of the coefficients wⱼ of the polynomial W_{g} remains the same.

As mentioned in the section entitled “summary”, the degree N−1 of the polynomial W_{g}(X) can be chosen so that N is below 50 times pᵢ, or even below 30 times pᵢ, which is high enough to avoid enables erasing or degrading the message mᵢ, while leading to a reasonably fast execution of this bootstrapping procedure.

Besides, N may be chosen as equal to or higher pᵢ, or even than 5 times pᵢ. The coefficients wⱼ of W_{g}(X) are then numerous enough to adjust the polynomial W_{g}(X) to any, arbitrary function g, from Tₚᵢ to Tₚᵢ.

Some details regarding the homomorphic evaluation of coef₀(X^{q}·W_{g}(X)) in itself are presented now. They are outlined briefly, as this evaluation is carried on in a way similar to prior art techniques (such as the one described in ***Ref1), apart from the specific choice of the polynomial W_{g}(X).

As known in the art, a polynomial such as X^{q}·W_{g}(X) modulo (X^{N}+1) can be decomposed into several successive modular products:

X^{q}·W_{g}(X)=X^{-ā}^{ₙ}^{s}^{ₙ}·( . . . (X^{-ā}^{₁}^{s}^{₁}·(X^{-b̅}·W_{g}(X))) . . . )

where b̅−Σₖ₌₁ⁿāₖSₖ≈└2N(bᵢ−aᵢ·s)┐=q.

In the equation above, each product “·” is a modular product: the left term, for instance X^{-b̅}, or X^{-ā}^{₁}^{s}^{₁}, belongs to Z_{N}[X], while the right term, for instance W_{g}(X), or (X^{-b̅}·W_{g}(X)), belongs to T_{pi,N}[X]. Such a product is completely similar to the product y·mᵢ of an integer number y with a number mᵢ belonging to Tₚᵢ, which is usually designated as a modular product (due to the modular structure of Tₚᵢ, defined modulo 1).

It is known that a modular product y·mᵢ, or X^{j}·W_{g}(X), can be computed homomorphically in the form of a so-called external product X_{S′}(y) [symbol] \tilde{φ}ₛ(mᵢ) where \tilde{φ}ₛ(mᵢ)=cᵢ is the encrypted version of the message mᵢ (cᵢbeing computed as explained above), and where X_{S′}(z) is the so-called TGSW encrypted form of z (TGSW standing for “Gentry, Sahai, Waters” Torus encryption, the TGSW scheme having been suggested in the article “Homomorphic encryption from learning with errors: Conceptually-simpler, asymptotically-faster, attribute-based”, by C. Gentry, A. Sahai, and B. Waters, InCrypto '13, 2013).

Besides, as known in the art, a quantity like X_{S′}(X^{-ā}^{ₖ}^{s}^{ₖ}) [symbol] \tilde{φ}ₛ(m) can be computed without knowing the secret key component sₖ, k=1 . . . n (more generally, without knowing the secret key s).

Indeed, as the secret key components sₖ, k=1 . . . n belong each to B={0, 1}, the quantity X^{-ā}^{ₖ}^{s}^{ₖ} is equal to (X^{-ā}^{ₖ}−1)sₖ+1 which is encrypted as (X^{-ā}^{ₖ}−1)·X_{S′}(sₖ)+H_{B}^{l}.

And so, an encrypted version of X^{q}·W_{g}(X) modulo (X^{N}+1) can be computed without knowing or having access to the secret key s as it can be computed using an encrypted versions X_{S′}(sₖ) of the secret key components sₖ, sometimes designated as a Bootstrap Key BKₖ in the literature. Usually, the Bootstrap Key BKₖ=X_{S′}(sₖ), which is an encrypted version of the secret key component sₖ, encrypted using another key s′, is a public key.

The way to compute the TGSW encrypted version X_{S′}(y) of an integer number y or, equivalently, to compute the TRGSW (GSW Torus ‘Ring’) encrypted version X_{S′},(P) of a polynomial P belonging to Z_{N}[X], is recalled below. The way to compute the external product [symbol] is also recalled.

X_{S′}(y) is defined as being equal to Z+yH_{B}^{l} with:

$$Z = ( \begin{matrix}{z}_{1} \\ ⋮ \\ {z}_{l ( n + 1 )}\end{matrix} ) ,$$

where the zⱼ, j=1 . . . l(n+1) are l(n+1) distinct encrypted versions of 0, the null value 0 being encrypted with s′:zⱼ=\tilde{φ}_{S′}(0), and where l is a given, fixed integer number; and
H_{B}^{l} a matrix whose dimension is (n+1)×(n+1)×l and whose coefficients belong to the Torus T, H_{B}^{l} being equal to:

$${H}_{B}^{l} = ( \begin{matrix}h & 0 & … \\ 0 & h & ⋱ \\ ⋮ & ⋱ & ⋱\end{matrix} ) with h = ( \begin{matrix}1 / B \\ ⋮ \\ 1 / {B}^{l}\end{matrix} ) ,$$

B being an integer number higher than or equal to 2.

The external product C [symbol] c, between:
an encrypted message c=\tilde{φ}_{S′}(m), c∈Tⁿ⁺¹, corresponding to a message m belonging to the discrete torus Tₚᵢ, more generally to the torus T, and
an encrypted version C=X_{S′}(y) of an integer number y, C∈ [symbol] (T), is computed as explained below.

The n+1 components cⱼ, j=1 . . . n+1 of the encrypted message c=\tilde{φ}_{S′}(m) are each decomposed, using a kind of numeral system of base B (like the one used to compute X_{S′}):

$${c}_{j} \approx {\sum }_{u = 1}^{l} \frac{{c}_{j}^{u}}{{B}^{u}} mod ( 1 ) ,$$

$$0 \leq \vert {c}_{j}^{u} \vert \leq B - 1$$

Then, one computes

C [symbol] c=Σ_{B,l}(c)C

where Σ_{B,l}(c) C denotes the usual row-vector matrix product and where Σ_{B,l}(c) is a matrix of dimension (n+1)×l whose expression is:

Σ_{B,l}(c)=(σ_{B,l}(c₁), . . . , σ_{B,l}(cⱼ), . . . , σ_{B,l}(cₙ₊₁))

with σ_{B,l}(cⱼ)=(cⱼ¹, . . . , cⱼ^{u}, . . . , cⱼ^{l})^{T}.

The result, C [symbol] c, which belongs to Tⁿ⁺¹, is an encrypted version of y·m. In other words, decrypting this quantity using s gives y·m.

This technique can be applied to any message m belonging to the torus T. So, it can also be applied, like here, to messages belonging to the discrete torus Tₚᵢ.

### Homomorphic Multiplication

First, it is noted that the usual, natural multiplication cannot be used as such for multiplying two messages belonging to the discrete torus Tₚᵢ.

For elements belonging to the discrete torus Tₚᵢ, a multiplication, noted ×_{T}, can however be defined, according to the following equation:

m3ᵢ=m1ᵢ×_{T}m2ᵢ:=(x1ᵢ·x2ᵢ mod(pᵢ))/pᵢ=(m1ᵢ·m2ᵢ)·pᵢ mod(1)

where m1ᵢ=x1ᵢ/pᵢ and m2ᵢ=x2ᵢ/pᵢ each belong each to Tₚᵢ, x1ᵢ and x2ᵢ being integer numbers, and where “·” is the usual, natural multiplication.

Clearly, the product m3ᵢ=m1ᵢ×_{T}m2ᵢ belongs also to Tₚᵢ. Besides, this multiplication between elements of the discrete torus complies with the modular nature of Tₚᵢ. Indeed, for any couple of messages m1ᵢ, m2ᵢ belonging to Tₚᵢ²:

(m1ᵢ+1)×_{T}m2ᵢ=((x1ᵢ+pᵢ)·x2ᵢ mod(pᵢ))/pᵢ=(x1ᵢ·x2ᵢ mod(pᵢ))/pᵢ

as x2ᵢ is an integer number, and so, (m1ᵢ+1)×_{T}m2ᵢ=m1ᵢ×_{T}m2ᵢ.

The homomorphic multiplication procedure described here is noted ⊙.

It produces a cyphertext c3ᵢ=c1ᵢ⊙c2ᵢ which is an encrypted version of m3ᵢ=m1ᵢ×_{T}m2ᵢ, c1ᵢ and c2ᵢ being encrypted versions of m1ᵢ and m2ᵢ respectively.

To determine c3ᵢ, that is to say to determine homomorphically the quantity (x1ᵢ·x2ᵢ)/pᵢ mod (1), the bootstrapping procedure described above is exploited, as well as the fact that xy=((x+y)²−(x−y)²)/4.

This identity is employed to switch from the two-operands multiplication operation xy to a single-operand squaring operation, this squaring operation being carried on homomorphically thanks to this specific bootstrapping procedure (thanks to an appropriate choice of the function g).

More precisely, to determine homomorphically m1ᵢ×_{T}m2ᵢ=(x1ᵢ·x2ᵢ)/pᵢ mod(1), one determines homomorphically the quantity M below:

$$M = \frac{( {p}_{i} + 1 )}{2} \cdot [ \frac{( {p}_{i} + 1 )}{2} \cdot {p}_{i} \cdot {( m {1}_{i} + m {2}_{i} )}^{2} - \frac{( {p}_{i} + 1 )}{2} \cdot {p}_{i} \cdot {( m {1}_{i} - m {2}_{i} )}^{2} ]$$

where (m1ᵢ+m2ᵢ)²=(m1ᵢ+m2ᵢ)·(m1ᵢ+m2ᵢ), “·” being the usual, natural multiplication.

Indeed,

$$\frac{( {p}_{i} + 1 )}{2} \cdot [ \frac{( {p}_{i} + 1 )}{2} \cdot {p}_{i} \cdot {( m {1}_{i} + m {2}_{i} )}^{2} - \frac{( {p}_{i} + 1 )}{2} \cdot {p}_{i} \cdot {( m {1}_{i} - m {2}_{i} )}^{2} ] = \frac{( {p}_{i} + 1 )}{2} \cdot [ \frac{( {p}_{i} + 1 )}{2} \cdot \frac{{( x {1}_{i} + x {2}_{i} )}^{2}}{{p}_{i}} - \frac{( {p}_{i} + 1 )}{2} \cdot \frac{{( x {1}_{i} - x {2}_{i} )}^{2}}{{p}_{i}} ] = \frac{( {p}_{i} + 1 )}{2} \cdot 2 \cdot \frac{x {1}_{i} \cdot x {2}_{i}}{{p}_{i}} = \frac{x {1}_{i} \times x {2}_{i}}{{p}_{i}}$$

as (pi+1)/2 is the inverse of 2, in Zₚᵢ.

In this respect, it is noted that it is useful to have pᵢ odd, as it allows 2 to be inversible, in Zₚᵢ.

To determine homomorphically the quantity

$$\frac{( {p}_{i} + 1 )}{2} \cdot {p}_{i} \cdot {( m {1}_{i} + m {2}_{i} )}^{2} - \frac{( {p}_{i} + 1 )}{2} \cdot {p}_{i} \cdot {( m {1}_{i} - m {2}_{i} )}^{2}$$

one computes G_{sq}(c1ᵢ⊕c2ᵢ)⊖G_{sq}(c1ᵢ⊖c2ᵢ) where G_{sq} denotes the bootstrapping procedure described above, in the particular case where the function g is the function:

$${g}_{sq} : {m}_{i} = {x}_{i} / {p}_{i} \to \frac{( {p}_{i} + 1 )}{2} \cdot {p}_{i} \cdot {( {m}_{i} )}^{2} = \frac{( {p}_{i} + 1 )}{2} \cdot [ {( {x}_{i} )}^{2} / {p}_{i} mod ( 1 ) ]$$

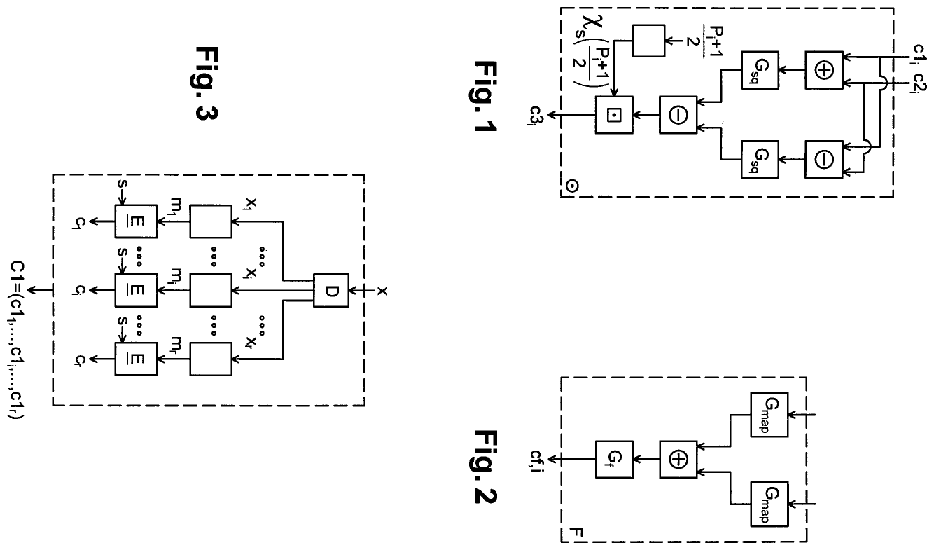

And so, finally c3ᵢ is determined, homomorphically, from c1ᵢ and c2ᵢ, according to the following equation, where [symbol] is the external product mentioned above (see FIG. 1):

$$c {3}_{i} = c {1}_{i} ⊙ c {2}_{i} = {χ}_{S} ( \frac{{p}_{i} + 1}{2} ) [ {G}_{sq} ( c {1}_{i} ⊕ c {2}_{i} ) ⊖ {G}_{sq} ( c {1}_{i} ⊖ c {2}_{i} ) ]$$

As the skilled person will appreciate, several modifications can be made to this homomorphic multiplication procedure, without departing from the disclosed technology. For instance, instead of using the bootstrapping “function” G_{sq} to determine homomorphically the quantity M, one could use another bootstrapping “function”, noted G_{sq}, which corresponds to the bootstrapping procedure described above in the particular case where the function g is the function:

g_{sq′}:mᵢ=xᵢ/pᵢ→mᵢ×_{T}mᵢ=pᵢ·(mᵢ)²=(xᵢ)²/pᵢ mod(1)

In this case the encrypted product ca is determined, homomorphically, according to the following equation:

$$c {3}_{i} = {χ}_{S} ( \frac{{p}_{i} + 1}{2} ) \text{} ( {χ}_{S} ( \frac{{p}_{i} + 1}{2} ) {G}_{{sq}^{′}} ( c {1}_{i} ⊕ c {2}_{i} ) ) ⊖ ( {χ}_{S} ( \frac{{p}_{i} + 1}{2} ) {G}_{{sq}^{′}} ( c {1}_{i} ⊖ c {2}_{i} ) ) ]$$

Still, using G_{sq} will enable a faster computation than G_{sq′}, as it prevents from computing two extra external products [symbol] .

And for even faster computation, c3ᵢ could be determined homomorphically, from c1ᵢ and c2ᵢ, according to the following equation:

c3ᵢ=c1ᵢ⊙c2ᵢ=G_{sq″}(c1ᵢ⊕c2ᵢ)⊖G_{sq″}(c1ᵢ⊖c2ᵢ)

where G_{sq″} denotes the bootstrapping function presented above in the case where the function g is the function:

$${g}_{sq ″} : {m}_{i} = {x}_{i} / {p}_{i} \to {[ \frac{( {p}_{i} + 1 )}{2} ]}^{2} \cdot {p}_{i} \cdot {( {m}_{i} )}^{2} = {[ \frac{( {p}_{i} + 1 )}{2} ]}^{2} \cdot [ {( {x}_{i} )}^{2} / {p}_{i} mod ( 1 ) ]$$

### Homomorphic Evaluation of a Two-Variable Function

The disclosed technology concerns also a method for evaluating a two-variable function, that is an arbitrary two-operands function, homomorphically.

Being able to evaluate such a quantity is very useful for homomorphic data bases processing. Indeed, it enables, inter alia, to compare two ciphers texts c1ᵢ and c2ᵢ without decrypting them (for instance to sort the data base). To this end, the two-variable function employed could be the Max, or Min function. In this respect, one may note that a function returning (in an encrypted form) the maximum, or the minimum of a set of two messages is a two-variable function. And due to the modular nature of the messages employed here, the maximum or minimum of two messages cannot be determined by simply looking at the sign of the difference of these two messages.

As explained below, to evaluate homomorphically a two-variable function f, each of the two inputs of this function (which belong each to Tₚᵢ) is mapped on a specifically designed set of values S. The elements μⱼ of Sbelong each to T, and such that, for any set of indexes (i,j,k,l) with (i,j)≠(k,l, (k,l) being also different from (j,i): α·μᵢ+β·μⱼ is different from α·μₖ+β·μₗ, modulo ½, where α and β are two constant and integer, given numbers.

### So:

∀(i, j)≠(k, l), with (j, i)≠:α·μᵢ+β·μⱼ≠α·μₖ+β·μₗ and α·μᵢ+β·μⱼ≠α·μₖ+β·μₗ+1/2

Then, taking advantage of this property, the two-operand function f is transformed into a one-operand function g_{f} by first computing a linear combination of these two messages (multiplied respectively by the coefficients α and β), in order to obtain a single operand (the two messages having been preliminarily mapped onto S). The one-operand function g_{f} is then homomorphically evaluated, by using the specific bootstrapping procedure described above.

More precisely, the two input messages m1ᵢ and m2ᵢ are first mapped onto corresponding elements of S, thanks to a mapping function gₘₐₚ:

gₘₐₚ: ∀m∈Tₚᵢ→m=gₘₐₚ(m)∈S

where m is one of the elements of S.

gₘₐₚ is chosen among the different possible functions that map Tₚᵢ on S.

It may be noted that it can be proven that it is always possible to build a set S fulfilling the condition above (and fulfilling also one the additional conditions given below for S). In practice, the set S can be chosen among different sets fulfilling these conditions. Preferably, the set S that is chosen is the one for which the values μⱼ of the set are the more spaced apart from each other.

The “mapped” messages associated respectively to m1ᵢ and m2ᵢ are noted m1ᵢ and m2ᵢ respectively: m1ᵢ=gₘₐₚ(m1ᵢ), m2ᵢ=gₘₐₚ(m2ᵢ)

The “one-operand” function g_{f} corresponding to f is then defined as:

∀(m1ⱼ,m2ⱼ)∈Tₚᵢ²g_{f}(α·m1ⱼ+β·m2ⱼ)=f(m1ⱼ,m2ⱼ)

that is:

∀(m1ⱼ,m2ⱼ)∈Tₚᵢ²g_{f}[α·gₘₐₚ(m1ⱼ)+β·gₘₐₚ(m2ⱼ)]=f(m1ⱼ,m2ⱼ)

The fact that two different couples of messages (m1ᵢ, m2ᵢ) and (m1′ᵢ, m2′ᵢ) always lead to two different values of the intermediate quantity α·m1ᵢ+β·m2ᵢ (respectively, α·m1′ᵢ+β·m2′ᵢ), due to the specific structure of S, is one of the elements that enables to apply the method to any, arbitrary two variable function f from Tₚᵢ×Tₚᵢ to Tₚᵢ, or even from Tₚᵢ×Tₚᵢ to T.

The encrypted version of f(m1ᵢ, m2ᵢ) is noted

c_{f,i}=F(c1ᵢ,c2ᵢ)

When c_{f,i} is decrypted using the secret key s, it gives f(m1ᵢ, m2ᵢ).

c_{f,i} is determined, homomorphically, from the ciphertexts c1ᵢ and c2ᵢ (without decrypting c1ᵢ or c2ᵢ), according to the following equation:

c_{f,i}=F(c1ᵢ, c2ᵢ)=G_{f}[(α·Gₘₐₚ(c1ᵢ))⊕(β·Gₘₐₚ(c2ᵢ))]

where Gf denotes the bootstrapping function described above in the particular case where g is g_{f}, and
where Gₘₐₚ denotes the bootstrapping function described above, in the particular case where g is gₘₐₚ.

It may be noted that the uncyphered values of α and β are used directly to compute c_{f,i}. In other words, the coefficients α and β are not ciphered.

This method can be applied to any function f (in particular, whether f is symmetric or not).

When the function f is symmetric, α and β are chosen equal to each other. For instance, they may be chosen each as being equal to 1. In this case, c_{f,i} is determined homomorphically from c1ᵢ and c2ᵢ according to the following equation (see FIG. 2):

c_{f,i}=G_{f}[Gₘₐₚ(c1ᵢ)⊕Gₘₐₚ(c2ᵢ)]

This way to compute c_{f,l} is beneficial as there is no multiplication by α or β to be carried on, and as the noise terms are not amplified, as they are multiplied by 1.

It may be noted that the Max(c1ᵢ, c2ᵢ) function, for instance, whose output is the cipher text c1ᵢ, or c2ᵢ, that is associated to the highest of the two messages m1ᵢ and m2ᵢ (highest, with respect to usual order of Tₚᵢ values), is a symmetric function.

When the function f is not symmetric, α and β are chosen different from each other, and the elements of S are such that, for any set of indexes (i,j,k,l) with (i,j)≠(k,l), α·μᵢ+β·μⱼ is different from α·μₖ+β·μₗ modulo ½, even when (k,l)=(j,i).

In this case, α and β can be chosen as being equal to +1 and −1 respectively, for instance. c_{f,i} is then determined homomorphically from c1ᵢ and c2ᵢ according to the following equation

c_{f,i}=G_{f}[Gₘₐₚ(c1ᵢ)⊖Gₘₐₚ(c2ᵢ)]

Again, this kind of implementation is beneficial, as it involves no multiplication by a coefficient higher than 1, and so no noise amplification.

This method for evaluating homomorphically a two-variable function has been presented above in a case where the function f is a function from Tₚᵢ×Tₚᵢ to Tₚᵢ, or from Tₚᵢ×Tₚᵢ to T. Still, it can be implemented identically when the two variables of the function f each belongs to a discrete set of pᵢ elements (possibly different from Tₚᵢ, but consisting of pᵢ elements, with pi odd, and such that twice the difference between any two of the elements of this set is not an integer number), the values of function f belonging to T.

Carry-less processing of a message m, by decomposing it into orthogonal sub-messages mᵢ.

As mentioned above, the disclosed technology also concerns a technique for encrypting and processing ‘very long’ messages x (or m), using a specific decomposition of the message x into smaller messages xᵢ, this decomposition being based on the Chinese remainder theorem decomposition and enabling to process the sub-messages xᵢ, or, for instance, their counterparts xᵢ/pᵢ, separately from each other, without having to take into account possible carries.

This technique can be applied to any message belonging to [symbol] ₚ= [symbol] /p [symbol] , p being equal to Πᵢ₌₁^{r}pᵢ, where the integer numbers pᵢ are pairwise coprime.

More precisely, for any message x belonging to [symbol] ₚ, the corresponding encrypted message C is determined by executing the following operations (FIG. 3):
Step D: decomposing x into its components xᵢ, i=1 . . . r, with xᵢ equal to x modulo pᵢ (the Chinese remainder theorem stating that such a decomposition is always possible),
Step E: for each component xᵢ whose associated factor pᵢ is odd, determining an encrypted version cᵢ of a message mᵢ, according to the encryption method presented above, mᵢ being, among the elements of the discrete set of pᵢ elements mentioned above (e.g.: Tₚᵢ), the element that is associated to xᵢ by a given bijective relationship between [symbol] ₚᵢ and said discrete set,
if a component xᵢ is associated to a factor pᵢ equal to 2, determining an encrypted version cᵢ of a quantity Qᵢ associated to xᵢ and that can takes two distinct values, cᵢ being equal to (aᵢ,bᵢ) with bᵢ=Qᵢ+eᵢ+aᵢ·s,
returning C=(c₁, . . . cᵢ, . . . cᵣ).

Below, we consider the case in which the discrete set consisting of pᵢ distinct elements is Tₚᵢ. The component xᵢ may be associated (bijectively) to a corresponding element mᵢ of Tₚᵢ according to the following equation, for instance: mᵢl=xᵢ/pᵢ, or according to the following equation mᵢ=xᵢ/pᵢ, or, alternatively, according to the following equation mᵢ=(xᵢ+1)/pᵢ.

Besides, we consider below that the same secret key s is used on the different fields [symbol] ₚ₁, . . . , [symbol] ₚᵢ, . . . , [symbol] ₚᵣ. In other words, here, the same secret key s is used to cipher the different messages m₁, . . . mpᵢ, . . . mᵣ. Still, in alternative, different keys could be used to cipher the different (sub-) messages m₁, . . . mᵢ, . . . mᵣ.

In may be noted that, in other embodiments, the discrete set in question may be another set than Tₚᵢ, and that another operation than the one mentioned above could be used to map [symbol] ₚᵢ onto this discrete set (for instance, mi could be obtained by multiplying xᵢ by any integer number that is coprime with pᵢ, and then be divided by pᵢ).

Besides, here, the decomposition of x is carried on such that the only even factor pᵢ, should there be one, is two. So, except from, possibly, a factor two, all the other factors pi are odd. And so, their corresponding messages mᵢ can all be processed, individually, according to the methods described in detail above, for elements belonging to Tₚᵢ, except, possibly, for one of them, associated to a factor pᵢ equal to two, which is processed, for instance, according to existing, known techniques for binary messages.

When processing such an encrypted message C=(c₁, . . . cᵢ, . . . cᵣ), or when processing a couple (C1, C2) of two such messages C1=(c1₁, . . . c1ᵢ, . . . c1ᵣ) and C2=(c2₁, . . . c2ᵢ, . . . c2ᵣ), the components c₁, . . . cᵢ, . . . cᵣ of C, or the couples of components (c1₁, c2₁) . . . (c1ᵢ, c2ᵢ), . . . (c1ᵣ, c2ᵣ) are processed, homomorphically, independently from each other (that is, without taking into account any carry).

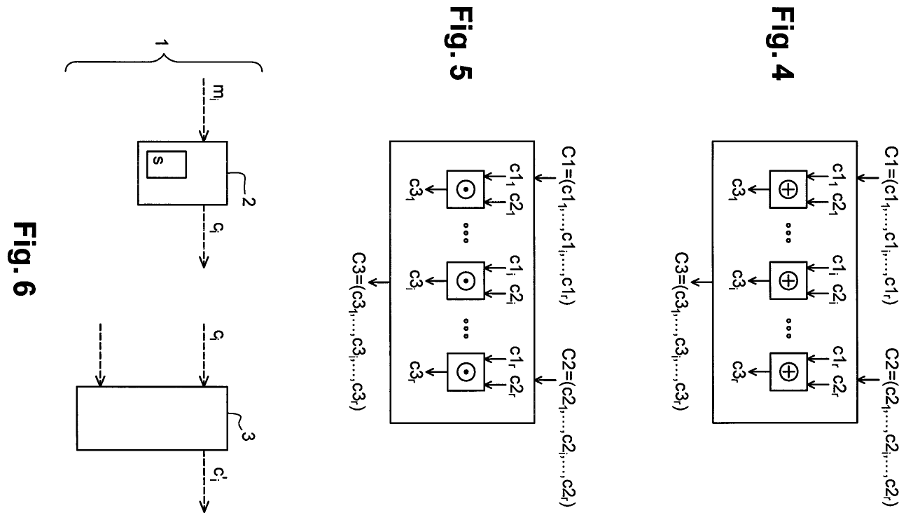

For instance, the homomorphic addition of two such messages C1 and C2 is achieved as follow (see FIG. 4):

C1⊕C2=(c1₁⊕c2₁, . . . , c1ᵢ⊕c2ᵢ, . . . c1ᵣ⊕c2ᵣ)

Similarly, the homomorphic multiplication of two such messages C1 and C2 is achieved as follow, based on the Tₚᵢ×Tₚᵢ homomorphic multiplication ⊙ presented above (see FIG. 5):

C1⊙C2=(c1₁⊙c2₁, . . . , c1ᵢ⊙c2ᵢ, . . . c1ᵣ⊙c2ᵣ)

Similarly, a refreshed version C′ of such an encrypted message C=(c₁, . . . cᵢ, . . . cᵣ) is determined by computing the following quantity C′=(G(c₁), . . . G(cᵢ), . . . , G(cᵣ)).

### Electronic Devices and System

FIG. 6 represents schematically a cryptographic system 1 comprising an encrypting device 2 and a processing device 3, for processing encrypted messages without decrypting them.

The encrypting device 2 and the processing device 3 comprise each at least one processor, and at least one memory.

The encrypting device 2 is programmed, or otherwise arranged for executing the following steps:
receiving data representative of an unencrypted message mᵢ, that belongs to a discrete set consisting of pᵢ distinct elements, with pᵢ being an odd number, said discrete set being the discrete torus

$${T}_{pi} = \frac{1}{{p}_{i}} \{ - \frac{{p}_{i} - 1}{2} , - \frac{{p}_{i} - 1}{2} + 1 , … , \frac{{p}_{i} - 1}{2} - 1 , \frac{{p}_{i} - 1}{2} \} ,$$

or the set T_{pi,N}[X] of polynomials of degree N−1 whose coefficients belong to Tₚᵢ, or to another discrete set in bijective relationship with Tₚᵢ,
processing said data according to the method for encrypting such messages, that has been presented above, to determine encrypted data representative of the encrypted message cᵢ, the secret key s employed during said processing, for instance stored, at least temporarily, in the memory of the encrypting device, being accessed by the processor or processors during said processing.

The processing device 3, which is distinct from the encrypting device 2, is configured for receiving the encrypted message cᵢ from the encrypting device 2, and, possibly, to receive other such encrypted messages.

The processing device 3 is programmed, or otherwise arranged to execute the following steps:
receiving data, representative of the encrypted message cᵢ produced by the encrypting device 2,
processing said data, according to the method for bootstrapping described above, to determine refreshed data, representative of the encrypted message c′ᵢ, said processing being achieved without decrypting cᵢ and without using, reading or accessing the secret key s.

In particular, during this bootstrapping, the unencrypted message mᵢ corresponding to cᵢ does not appear nor result from an operation, nor it is used, read or accessed. The unencrypted message mᵢ, just as the secret key s, thus remains absent from the processing device 3 at all time.

The processing device could also be programmed to execute the homomorphic multiplication method presented above and/or to homomorphic evaluate of a two-variable function like the one presented above.

The processing device 3 could also be programmed to execute one or several of the homomorphic processing methods for encrypted messages like the message C=(c₁, . . . cᵢ, . . . cᵣ), that has been presented above. And the encrypting device 2 could be programmed to produce such encrypted messages, from unencrypted messages x belonging to Zₚ.

1. Method for determining an encrypted message cᵢ, which is an encrypted version of a message mᵢ, cᵢ being equal to (aᵢ,bᵢ) where bi is determined from mᵢ and from a secret key s, bᵢ being equal to mᵢ+eᵢ+aᵢ·s with aᵢ being a randomly selected vector for projecting s and eᵢ being a random noise component added to mᵢ+aᵢ·s,
wherein the message mᵢ belongs to a discrete set consisting of pᵢ distinct elements, with pᵢ being an odd number, the elements of said discrete set being such that twice the difference between any two of these elements is not an integer number, said discrete set being the discrete torus
$${T}_{pi} = \frac{1}{{p}_{i}} \{ - \frac{{p}_{i} - 1}{2} , - \frac{{p}_{i} - 1}{2} + 1 , … , \frac{{p}_{i} - 1}{2} - 1 , \frac{{p}_{i} - 1}{2} \} ,$$
or the set T_{pi,N}[X] of polynomials of degree N−1 whose coefficients belong to Tₚᵢ, or another discrete set in bijective relationship with Tₚᵢ.

2. A Method for bootstrapping the encrypted message cᵢ=(aᵢ,bᵢ) determined according to claim 1, the method for bootstrapping comprising a determination of a refreshed encrypted message cᵢ40 =(aᵢ′,bᵢ′), which is an encrypted version of a value g(mᵢ) of a function g applied to the message mᵢ, cᵢ′ having a noise component eᵢ′ smaller than eᵢ.

3. The method according to claim 2, wherein the determination of cᵢ′ comprises a step of determining homomorphically the constant coefficient coef₀(X^{q}·W_{g}(X)) of X^{q}·W_{g}(X) mod (X^{N}+1), where
W_{g}(X)=Σⱼ₌₀^{N-1}wⱼ·X^{j} is a polynomial of degree N−1 whose coefficients wⱼ are given by the following formula:
(−1)^{┌└2Nm}^{ᵢ}^{┐/N┐}·w_{j=g}(mᵢ), where j=N┌└2Nmᵢ┐/N┐−└2Nmᵢ┐
with └2Nmᵢ┐ being the integer number that is the nearest to 2Nmᵢ and with ┌└2Nmᵢ┐/N┐ being the ceiling function applied to └2Nmᵢ┐/N, and where
q is the integer number that is the nearest to 2N(bᵢ−aᵢ·s): q=└2N(bᵢ−aᵢ·s)┐.

4. The method according to claim 3, wherein N is below 50 times pᵢ, or even below 30 times pᵢ.

5. The method according to claim 3, wherein N is above pᵢ, or even above 5 times pᵢ.

6. Method for homomorphically multiplying two messages m1ᵢ and m2ᵢ, each belonging to the discrete torus Tₚᵢ or to the set of polynomials T_{pi,N}[X], the method comprising a determination of an encrypted message c3ᵢ which is an encrypted version of the product of m1ᵢ by m2ᵢ, c3ᵢ being determined from encrypted messages c1ᵢ and c2ᵢ without decrypting c1ᵢ or c2ᵢ, c1ᵢ and c2ᵢ being encrypted versions of m1ᵢ and m2ᵢ respectively, that have been determined according to the method of claim 1,
the determination of c3ᵢ comprising homomorphically determining
$$\frac{( {p}_{i} + 1 )}{2} \cdot [ \frac{( {p}_{i} + 1 )}{2} \cdot {p}_{i} \cdot {( m {1}_{i} + m {2}_{i} )}^{2} - \frac{( {p}_{i} + 1 )}{2} \cdot {p}_{i} \cdot {( m {1}_{i} - m {2}_{i} )}^{2} ]$$
Where pᵢ·(m1ᵢ+m2ᵢ)² and pᵢ·(m1ᵢ−m2ᵢ)², or
$$\frac{( {p}_{i} + 1 )}{2} \cdot {p}_{i} \cdot {( m {1}_{i} + m {2}_{i} )}^{2}$$
$$and$$
$$\frac{( {p}_{i} + 1 )}{2} \cdot {p}_{i} \cdot {( m {1}_{i} - m {2}_{i} )}^{2} ,$$
$$or$$
$${[ \frac{( {p}_{t} + 1 )}{2} ]}^{2} \cdot {p}_{i} \cdot {( m {1}_{i} + m {2}_{i} )}^{2}$$
$$and$$
$${[ \frac{( {p}_{t} + 1 )}{2} ]}^{2} \cdot {p}_{i} \cdot {( m {1}_{i} - {m2}_{i} )}^{2}$$
are determined homomorphically by executing the method for bootstrapping according to any of claims 2 to 5, the function the function g being the function g_{sq′}:mᵢ→pᵢ·(mᵢ)² mod(1), or
$${g}_{sq} : {m}_{i} \to \frac{( {p}_{i} + 1 )}{2} \cdot [ {p}_{i} \cdot {( {m}_{i} )}^{2} mod ( 1 ) ] ,$$
or, respectively,
$${g}_{sq ″} : {m}_{i} \to {[ \frac{( {p}_{i} + 1 )}{2} ]}^{2} \cdot [ {p}_{i} \cdot {( {m}_{i} )}^{2} mod ( 1 ) ] .$$

7. Method for determining an encrypted message c_{f,i}, which is an encrypted version of a value f(m1ᵢ,m2ᵢ) of a two-variable function f applied to messages m1ᵢ and m2ᵢ m1ᵢ and m2ᵢ belonging each to said discrete set,
c_{f,i} being determined from encrypted messages c1ᵢ and c2ᵢ without decrypting c1ᵢ or c2ᵢ, c1ᵢ and c2ᵢ being encrypted versions of m1ᵢ and m2ᵢ respectively, that have been determined according to the method of claim 1,
the determination of c_{f,i} comprising:
determining c1′ᵢ and c2′ᵢ, from c1ᵢ and c2ᵢ respectively, by executing the method for bootstrapping, the function g employed during this bootstrapping being a function gₘₐₚ that maps said discrete set onto a set S whose elements μⱼ belong each to the torus T=]−1/2, 1/2] and are such that, for any set of indexes (i,j,k,l) with (i,j)≠(k,l), (k,l) being different from (j,i):
α·μᵢ+β·μⱼ is different from α·μₖ+β·μₗ modulo ½,
with α and β being two constant and integer, given numbers,
c1′ᵢ and c2′ᵢ being the encrypted versions of m1ᵢ=gₘₐₚ(m1ᵢ) and m2ᵢ gₘₐₚ(m2ᵢ) respectively, where m1ᵢ and m2ᵢ belong each to S,
determining homomorphicically, from c1′ᵢ and c2′_{I}, an encrypted message cₛ which is an encrypted version of α·m1ᵢ+β·m2ᵢ,
determining c_{f,i} from cₛ by executing the method for bootstrapping according to any of claims 2 to 5, the function g employed during this bootstrapping being a one-variable function g_{f} defined by the following condition: for any couple of messages m1ⱼ, m2ⱼ belonging each to said discrete set,
g_{f}(α·m1ⱼ+β·m2ⱼ)=f(m1ⱼ, m2ⱼ)
that is:
g_{f}[α·gₘₐₚ(m1ᵢ)+β·gₘₐₚ(m2ᵢ)]=f(m1ᵢ, m2ᵢ).

8. The method according to claim 7, wherein the elements of the set S are such that for any set of indexes (i,j,k,l) with (i,j)≠(k,l), α·μᵢ+β·μⱼ is different from α·μₖ+β·μₗ modulo ½, even when (k,l)=(j,i).

9. The method according to claim 8, wherein α=1 and β=−1, cₛ being determined by computing the homomorphic difference ⊖between c1′ᵢ and c2′: cₛ=c1′ᵢ⊖c2′ᵢ, or wherein α=−1 and β=1, cₛ being determined by computing the homomorphic difference ⊖ between c2′ᵢ and c1′: cₛ=c2′ᵢ⊖c1′ᵢ.

10. The method according to claim 7, wherein the function f is symmetric, f(m1ᵢ,m2ᵢ) being equal to f(m2ᵢ,m1ᵢ) for any couple of messages m1ᵢ and m2ᵢ, and wherein α and β are each equal to 1, cₛ being determined by computing the homomorphic sum ⊕ of c1′ᵢ and c2′: cₛ=c1′ᵢ⊕c2′ᵢ.

11. The method for determining an encrypted message C, which is an encrypted version of a message x belonging to [symbol] ₚ= [symbol] /p [symbol] , p being equal to Πᵢ₌₁^{r}pi where the integer numbers pᵢ are pairwise coprime, the method comprising:
(D) decomposing x into its components xᵢ, i=1 . . . r, with xᵢ equal to x modulo pᵢ,
(E) for each component xᵢ whose associated factor pᵢ is odd, determining an encrypted version cᵢ of a message mᵢ, according to the method of claim 1, mᵢ being, among the elements of said discrete set, the element that is associated to xᵢ by a given bijective relationship between [symbol] ₚᵢ and said discrete set,
if a component xᵢ is associated to a factor pᵢ equal to 2, determining an encrypted version cᵢ of a quantity Qᵢ associated to xᵢ and that can takes two distinct values, cᵢ being equal to (aᵢ,bᵢ) with bᵢ=Qᵢ+eᵢ+aᵢ·s,
returning C=(c₁, . . . cᵢ, . . . cᵣ).

12. The method for bootstrapping the encrypted message C=(c1, . . . cᵢ, . . . cᵣ) determined according to claim 11, said method comprising:
for each cᵢ whose associated factor pᵢ is odd, determining a refreshed encrypted message c′ᵢ, from cᵢ, by executing the method for bootstrapping,
returning C′=(c′₁, . . . , c′ᵢ, . . . c′ᵣ).

13. The method for determining an encrypted message C3=(c3₁, . . . c3ᵢ, . . . c3ᵣ), which is an encrypted version of the product of two messages x1 and x2, each belonging to [symbol] ₚ,
C3 being determined from encrypted messages C1 and C2, without decrypting C1 or C2, C1 and C2 being encrypted versions of x1 and x2 respectively, C1=(c1₁, . . . c1ᵢ, . . . c1ᵣ) and C2=(c2₁, . . . c2ᵢ, . . . c2ᵣ) having been determined from x1 and x2 respectively, according to the method of claim 11, wherein said discrete set is Tₚᵢ or T_{pi,N}N[X],
wherein each component c3ᵢ of C3 is determined from the corresponding components c1ᵢ and c2ᵢ of C1 and C2, when c1ᵢ and c2ᵢ are associated to a factor pᵢ that is odd.

14. Encrypting device, comprising one or more processors and at least one memory, the encrypting device being programmed to make the processor or processors executing the following steps:
receiving data representative of an unencrypted message mᵢ, that belongs to a discrete set consisting of pᵢ distinct elements, with pᵢ being an odd number and wherein the elements of said discrete set are such that twice the difference between any two of these elements is not an integer number, said discrete set being the discrete torus
$${T}_{pi} = \frac{1}{{p}_{i}} \{ - \frac{{p}_{i} - 1}{2} , - \frac{{p}_{i} - 1}{2} + 1 , … , \frac{{p}_{i} - 1}{2} - 1 , \frac{{p}_{i} - 1}{2} \} ,$$
or the set T_{pi,N}[X] of polynomials of degree N−1 whose coefficients belong to Tₚᵢ, or to another discrete set in bijective relationship with Tₚᵢ,
processing said data according to the method of claim 1, to determine encrypted data representative of the encrypted message cᵢ, the secret key s employed during said processing, stored at least transitorily in the memory of the encrypting device, being accessed by the processor or processors during said processing.

15. Cryptographic system comprising the encrypting device of claim 14 and a processing device,
the processing device comprising one or more processors and at least one memory, the processing device being programmed to make the processor or processors executing the following steps:
receiving data, representative of the encrypted message cᵢ that has been produced by the encrypting device,
processing said data, according to a method for bootstrapping, to determine refreshed data, representative of the encrypted message c′ᵢ, said processing being achieved without decrypting cᵢ and without using, reading or accessing the secret key s.

16. A non-transitory computer-readable medium comprising instructions that, when executed by a computer, make the computer to execute the bootstrapping method according to claim 2.

17. A non-transitory computer-readable medium comprising instructions that, when executed by a computer, make the computer to execute the encrypting method according to claim 11.
